(19) United States
(12) Patent Application Publication
(10) Pub. No.: US 2014/0177274 A1
(43) Pub. Date: Jun. 26, 2014

(54) LIGHT GUIDE ELEMENT AND LIGHT SOURCE DEVICE USING THE LIGHT GUIDE ELEMENT

(71) Applicant: RADIANT OPTO-ELECTRONICS CORPORATION, Kaohsiung (TW)

(72) Inventors: Wei-Hsuan CHEN, Kaohsiung (TW); Kai-Chun YANG, Kaohsiung (TW); Yuan-Chen CHUNG, Kaohsiung (TW)

(73) Assignee: Radiant Opto-Electronics Corporation, Kaohsiung (TW)

(21) Appl. No.: 13/868,122

(22) Filed: Apr. 23, 2013

(30) Foreign Application Priority Data
Dec. 24, 2012 (TW) 101149535

(51) Int. Cl. F21V 8/00

(52) U.S. Cl. CPC G02B 6/0096
USPC 362/611; 362/628

(57) ABSTRACT

A light guide element and a light source device using the same are provided. The light guide element has a main body. The side surface is located between the bottom surface and the light-emitting surface. The bottom surface is opposite to the light-emitting surface. The main body has a hollow portion with a cone shape. The cone-shaped hollow portion has a bottom portion and a top portion. The bottom portion is located on the bottom surface of the main body, and has a first hollow cross section area. The top portion is opposite to the bottom surface, and has a second cross section area smaller than the first cross section area. The light source device includes the light guide element and a light emitting diode (LED). The LED is used to emit light into the cone-shape hollow portion through the bottom portion.

### RELATED APPLICATIONS

This application claims priority to Taiwan Application Serial Number 101149535, filed Dec. 24, 2012, which is herein incorporated by reference.

### Field of the Invention

A light guide element and a light source device using the light guide element are provided, and more particularly, to a light guide element which can uniformize light and a light source device using the light guide element.

### BACKGROUND OF THE INVENTION

Light source devices play an important role in human life, and may be applied in various areas such as in a building, in a vehicle, or on a decoration article. Light source device is not only an illumination tool but has great impact on human daily life.

General light source devices include an incandescent lamp, a fluorescent lamp, and a light emitting diode (LED) lamp, etc. In a conventional incandescent lamp, electricity is conducted through tungsten filaments to generate light by high heat for illumination. However, such an incandescent lamp consumes a lot of power, and hence being gradually substituted by fluorescent lamps.

A fluorescent lamp generally applies high voltage on electrodes to emit electrons hitting mercury vapor atoms for generating ionization and excitation phenomena. When the mercury vapor atoms return to an original state from an excitation state, an invisible electromagnetic wave of 253.7 nm in wavelength is emitted. Thereafter, various fluorescent materials can be used to absorb and convert the electromagnetic wave into visible lights, such that the fluorescent lamp may emit various colors of light in accordance with the fluorescent materials.

Although the lighting efficiency of the fluorescent lamp is better than that of the incandescent lamp, yet in the society advocating energy saving and environmental protection, people still continue to develop new lighting devices which can meet requirements of energy saving and environmental protection for substituting the fluorescent lamp, because of the mercury vapor contained the fluorescent lamp. Therefore, a light-emitting diode (LED) lighting module is developed and greatly expected. When a LED is under a proper forward bias voltage, electrons and electron holes are respectively injected to N and P terminals. Then, the electrons and electron holes are combined at a P/N junction, thereby enabling the LED to emit light caused by the energy released in the form of light when the electrons drop to a basic state from an excited state to combine with the electron holes.

The lighting efficiency of the LED is better than that of the fluorescent lamp, and hence the LED has better energy saving performance than the fluorescent lamp. However, the light source device using the LED has poor light uniformity since the LED has a high directivity.

Therefore, there is a need to develop a novel light guide element and a light source device using the light guide element for providing uniform light.

### SUMMARY OF THE INVENTION

One aspect of the present invention is to provide a light guide element and a light source device using the light guide element. The light guide element has a cone-shaped hollow portion, and the cone-shaped hollow portion can uniformize light emitted from a light-emitting diode so as to enable the light source device using the light guide element to provide more uniform light.

According to an embodiment of the present invention, the light guide element includes a main body. The main body has a light-emitting surface, a bottom surface, and a side surface, wherein the side surface is located between the bottom surface and the light-emitting surface, and the bottom surface is opposite to the light-emitting surface. The main body has a cone-shaped hollow portion used to receive exterior light, and the cone-shaped hollow portion includes a bottom portion and a top portion. The bottom portion is located at the bottom surface, and has a first hollow cross-sectional area. The top portion is opposite to the bottom portion, and has a second hollow cross-sectional area, wherein the second hollow cross-sectional area is smaller than the first hollow cross-sectional area.

According to another embodiment of the present invention, the light source device includes a light guide element and a light source. The light guide element includes a main body. The main body has a light-emitting surface, a bottom surface, and a side surface, wherein the side surface is located between the bottom surface and the light-emitting surface, and the bottom surface is opposite to the light-emitting surface. The main body has a cone-shaped hollow portion used to receive exterior light, and the cone-shaped hollow portion includes a bottom portion and a top portion. The bottom portion is located at the bottom surface, and has a first hollow cross-sectional area. The top portion is opposite to the bottom portion, and has a second hollow cross-sectional area, wherein the second hollow cross-sectional area is smaller than the first hollow cross-sectional area. The light source is disposed adjacent to the bottom portion of the light guide element to emit light into the main body of the light guide element through the cone-shaped hollow portion.

It can be known form the above descriptions that the light guide element of the embodiment of the present invention uses the cone-shaped hollow portion to refract and diffuse light, thereby emitting the light of a light-emitting diode uniformly to exterior of the light guide element, and the light source device can provide more uniform light accordingly.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein:

FIG. 1 is a vertical cross-sectional view of a light source device in accordance with an embodiment of the present invention;

FIG. 1a is a cross-sectional view of a cone-shaped hollow portion in accordance with an embodiment of the present invention;

FIG. 1b is a diagram showing light paths of the light-emitting diode in the light guide element;

FIG. 2 is a vertical cross-sectional view of a light source device in accordance with an embodiment of the present invention;

FIG. 2a is a diagram showing a cubic structure of a cone-shaped hollow portion in accordance with an embodiment of the present invention;

FIG. 3 is a vertical cross-sectional view of a light source device in accordance with an embodiment of the present invention; and

FIG. 3a is a cross-sectional view of the cone-shaped hollow portion in accordance with an embodiment of the present invention.

### DETAILED DESCRIPTION

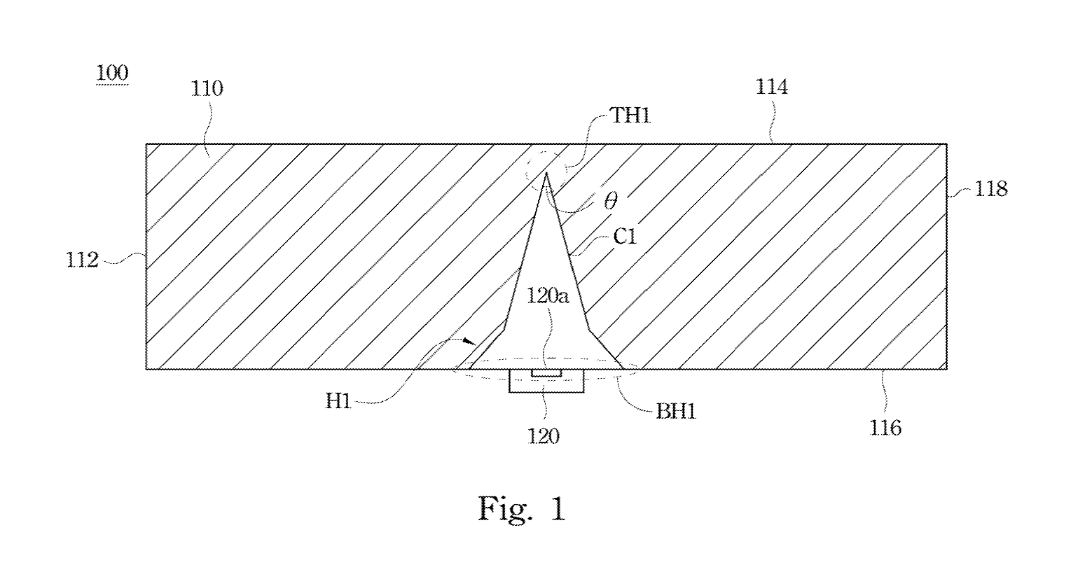

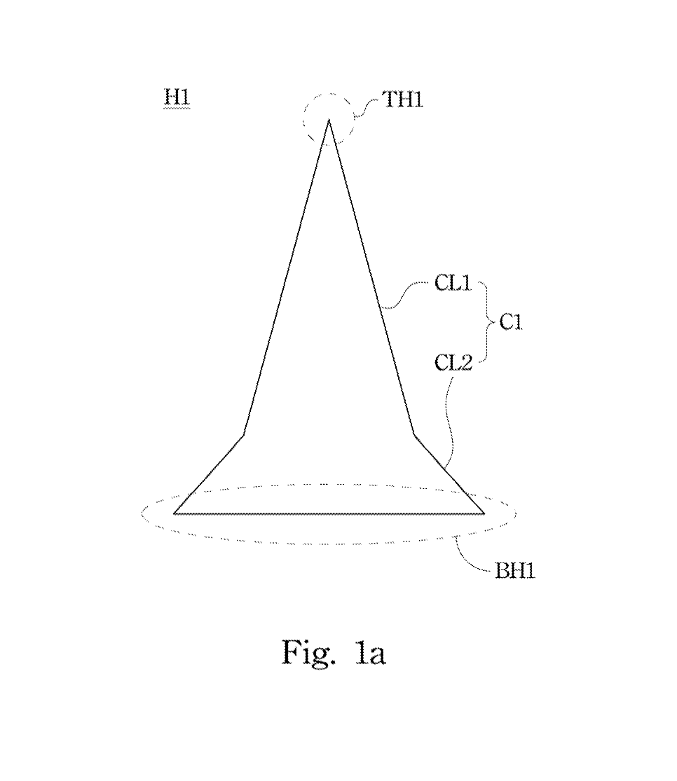

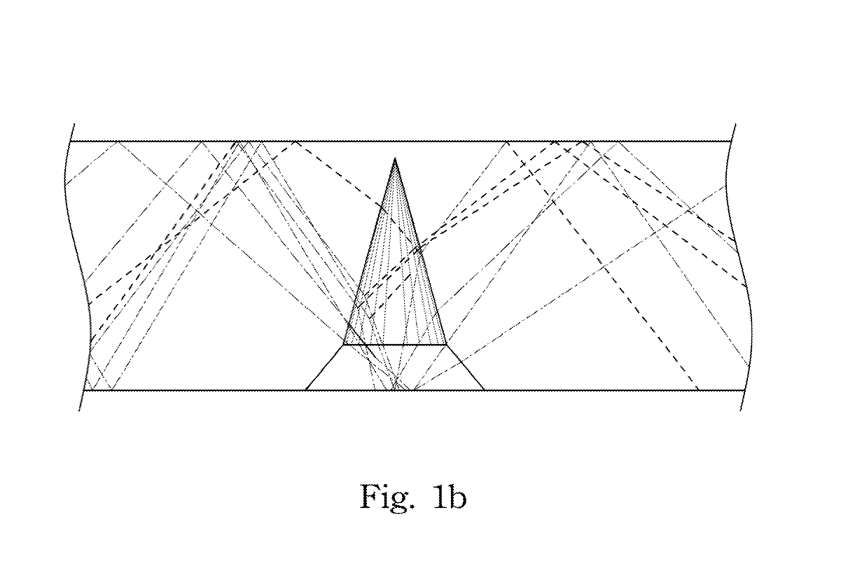

Referring to FIG. 1 and FIG. 1a simultaneously, FIG. 1 is a vertical cross-sectional view of a light source device 100 in accordance with an embodiment of the present invention, and FIG. 1a is a cross-sectional view of a cone-shaped hollow portion H1 in accordance with an embodiment of the present invention. The light source device 100 includes a light guide element 110 and a light-emitting diode 120. The light source device 100 of this embodiment uses the light-emitting diode 120 as a light source. However, embodiments of the present invention are not limited thereto, The light emitting diode 120 has a light-emitting surface 120a through which light is emitted to the light guide element 110.

A main body of the light guide element 110 has a light-emitting surface 114, a bottom surface 116 and side surfaces 112, 118, wherein the side surfaces 112 and 118 are located between the light-emitting surface 114 and the bottom surface 116, and the bottom surface 116 is opposite to the light-emitting surface 114. In this embodiment, the light-emitting surface 114 has microstructures for enabling the light in the light guide element 110 to be emitted out from the light guide element 110 through the light-emitting surface 114, but embodiments of the present invention are not limited thereto. In another embodiment, the bottom surface 116 may also have microstructures for enabling the light in the light guide element 110 to be emitted to out from the light guide element 110 through the bottom surface 116. Thus, two lighting directions can be provided. In addition, the light guide element 110 of this embodiment has two side surfaces, but embodiments of the present invention are not limited thereto. In another embodiment, the light guide element may have only one side surface. For example, the light guide element is a disc light guide element.

The main body of the light guide element 110 has the cone-shaped hollow portion H1, and the cone-shaped hollow portion H1 has a bottom portion BH1 and a top portion TH1. The bottom portion BH1 is located at the bottom surface 116 of the light guide element 110, and the top portion TH1 is located adjacent to the light-emitting surface 114 and is opposite to the bottom portion BH1. The top portion TH1 of the cone-shaped hollow portion H1 has a diameter r1, and the bottom portion BH1 has a diameter r2, wherein r2>r1. In other words, a horizontal cross-sectional area of the hollow portion of the top portion TH1 is smaller than that of the hollow portion of the bottom portion BH1. In this embodiment, a contour of a cross section of a sidewall of the cone-shaped hollow portion H1 is a curve C1, and the curve C1 is formed from a plurality of straight lines CL1 and CL2, wherein the slope of each of the straight lines CL1 and CL2 can be gradually increased, gradually decreased, or randomly arranged. In addition, an apex angle θ (e.g., cone opening angle) of the cone-shaped hollow portion H1 is in a range from 20 degrees to 65 degrees.

The light emitting diode 120 is disposed adjacent to the bottom portion BH1 of the cone-shaped hollow portion H1 to emit light into the light guide element 110. Referring to FIG. 1b, FIG. 1b is a diagram showing light paths of the light-emitting diode 120 in the light guide element 110, wherein doted lines represent the light paths of the light-emitting diode 120 in the light guide element 110. It can be understood from the FIG. 1b that, after the light emitted from the light emitting diode 120 enters the cone-shaped hollow portion H1, the light of the light emitting diode 120 may enter the light guide element 110 at various angles through sidewalls of the cone-shaped hollow portion H1, and hence the light of the light emitting diode 120 can be uniformly emitted out through the light-emitting surface 114 of the light guide element 110.

It can be known from the above descriptions that the light guide element 110 uses the cone-shaped hollow portion H1 to uniformize the light of the light emitting diode 120, such that the light source device 100 can provide uniform light.

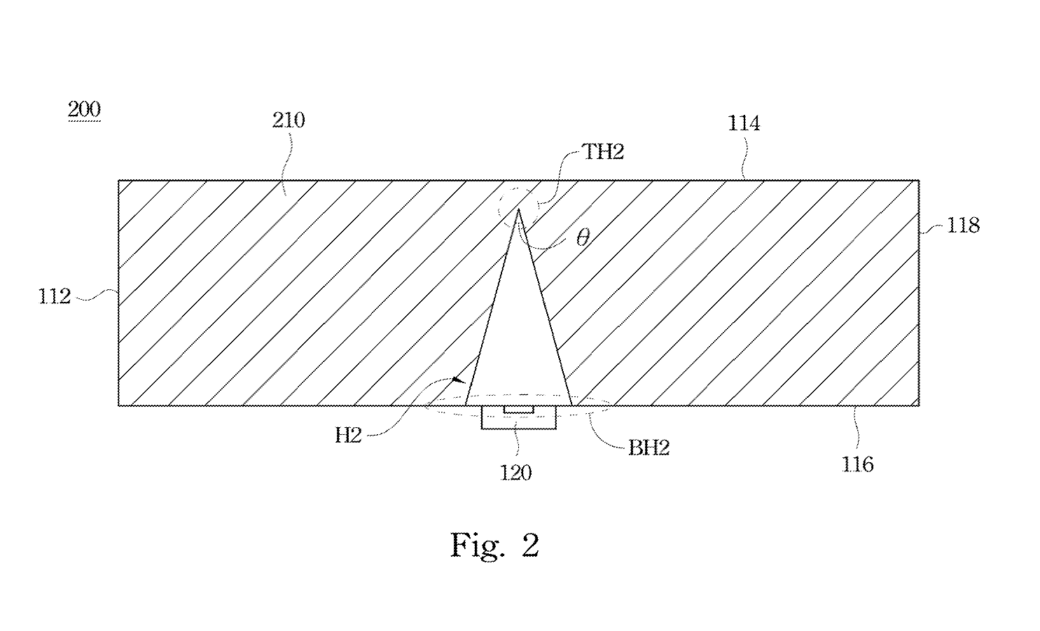

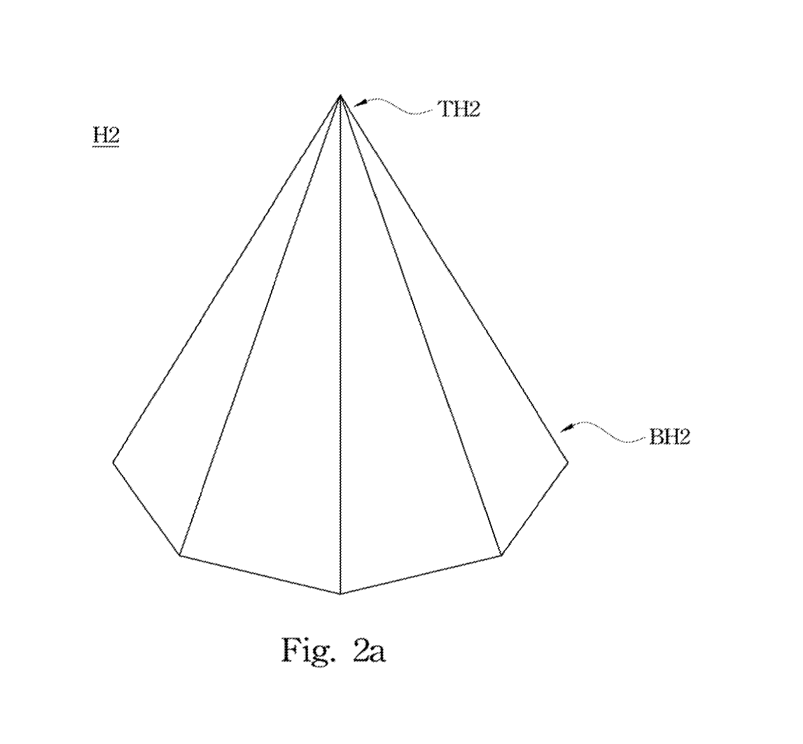

Referring to FIG. 2 and FIG. 2a simultaneously, FIG. 2 is a vertical cross-sectional view of a light source device 200 in accordance with an embodiment of the present invention, and FIG. 2a is a diagram showing a cubic structure of a cone-shaped hollow portion H2 in accordance with an embodiment of the present invention. The light source device 200 includes a light guide element 210 and the light-emitting diode 120. The guide element 210 is similar to the light guide element 110, but the difference is in that the light guide element 210 has a cone-shaped hollow portion H2.

The cone-shaped hollow portion H2 has a bottom portion BH2 and a top portion TH2. The bottom portion BH2 is located at the bottom surface 116 of the light guide element 210, and the top portion TH2 is located adjacent to the light-emitting surface 114 of the light guide element 210 and is opposite to the bottom portion BH2. The top portion TH2 of the cone-shaped hollow portion H2 has the diameter r1, and the bottom portion BH2 has the diameter r2, wherein r2>r1. In other words, a horizontal cross-sectional area of the hollow portion of the top portion TH2 is smaller than that of the hollow portion of the bottom portion BH2.

In this embodiment, the cone-shaped hollow portion H2 is in a shape of a polygon cone. However, embodiments of the present invention are not limited thereto. In another embodiment of the present invention, the cone-shaped hollow portion can be in a shape of a polygon cone, and a contour of a vertical cross section of sidewalls of the cone-shaped hollow portion is a curve or the line C1. In addition, the value of an apex angle of the cone-shaped hollow portion H2 is equal to the angle θ, and the shapes of cross sections of the bottom portion BH2 and the top portion TH2 can be the same or different from each other.

The light emitting diode 120 is disposed adjacent to the bottom portion BH2 of the cone-shaped hollow portion H2 to emit light into the light guide element 210. After the light of the light emitting diode 120 enters the cone-shaped hollow portion H2 sidewalls of the cone-shaped hollow portion H2 guide the light of the light emitting diode 120 to the light guide element 210 at various angles, hence the light of the light emitting diode 120 can be emitted out uniformly through the light-emitting surface 114 of the light guide element 210. It can be known from the above descriptions that the light guide element 210 of the embodiments of the present invention uses the cone-shaped hollow portion H2 to uniformize the light of the light emitting diode 120, and hence the light source device 200 can provide uniform light.

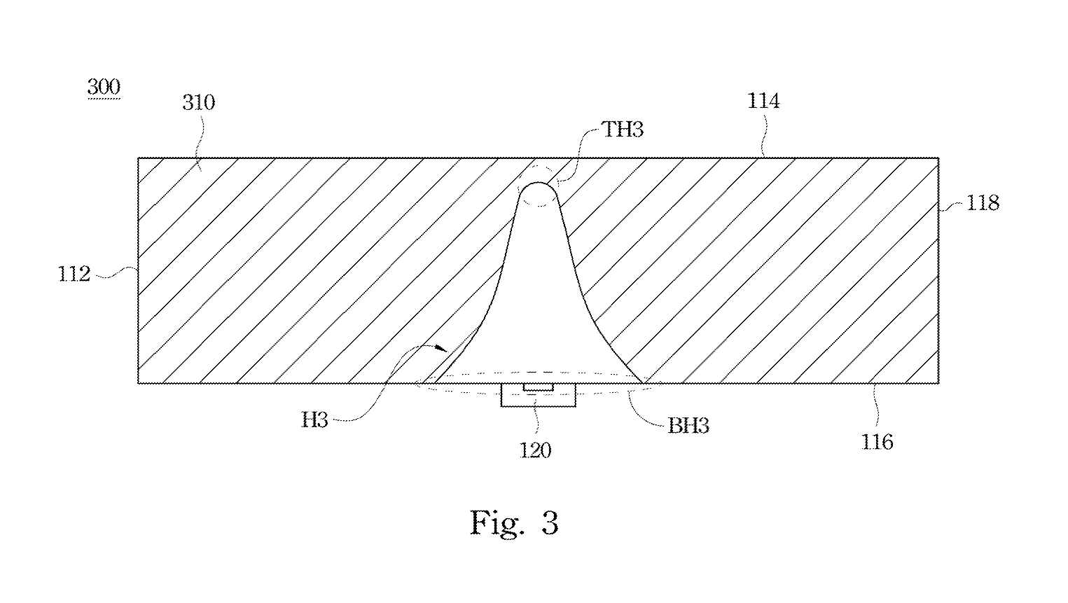

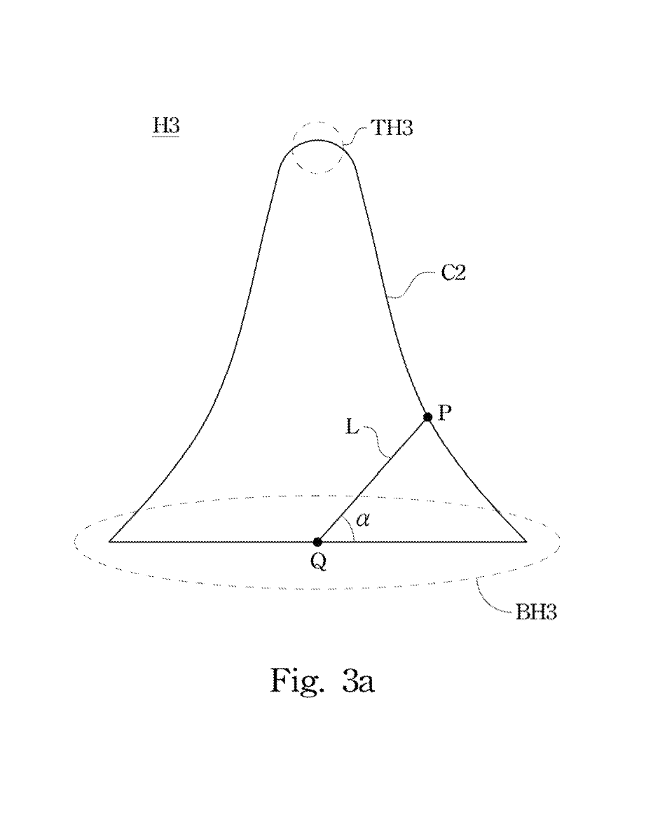

Referring to FIG. 3, FIG. 3 is a vertical cross-sectional view of a light source device 300 in accordance with an embodiment of the present invention. The light source device 300 includes a light guide element 310 and the light-emitting diode 120. The light guide element 310 is similar to the light guide element 110, but the difference is in that the light guide element 310 has a cone-shaped hollow portion H3.

The cone-shaped hollow portion H3 has a bottom portion BH3 and a top portion TH3. The bottom portion BH3 is located at the bottom surface 116 of the light guide element 310, and the top portion TH3 is located adjacent to the light-emitting surface 114 of the light guide element 310 and is opposite to the bottom portion BH3. The top portion TH3 of the cone-shaped hollow portion H3 has the diameter r1, and the bottom portion BH3 has the diameter r2, wherein r2>r1. In other words, a horizontal cross-sectional area of the hollow portion of the top portion TH3 is smaller than that of the hollow portion of the bottom portion BH3.

Referring to FIG. 3a simultaneously, FIG. 3a is a cross-sectional view of the cone-shaped hollow portion H3 in accordance with an embodiment of the present invention. In this embodiment, a contour of a cross section of a sidewall of the cone-shaped hollow portion H3 is a curve C2. A target point P on the curve C2 and a center point Q of the bottom portion BH3 form a straight line L, and there is an angle a included between the line L and the bottom portion BH3. When the value of the angle a is increased, a slope of a tangent line corresponding to the target point P is increased accordingly. In other words, the slope corresponding to the target point P is increased with the increasing height of the target point P, and a shape of the curve C2 is then formed as shown in FIG. 3a.

The light emitting diode 120 is disposed adjacent to the bottom portion BH3 of the cone-shaped hollow portion H3 to emit light into the light guide element 310. After the light of the light emitting diode 120 enters the cone-shaped hollow portion H3, sidewalls of the cone-shaped hollow portion H3 guide the light of the light emitting diode 120 to the light guide element 310 at various angles, hence the light of the light emitting diode 120 can be emitted out uniformly through the light-emitting surface 114 of the light guide element 310.

It can be known from the above descriptions that the light guide element 310 of the embodiments of the present invention uses the cone-shaped hollow portion H3 to uniformize the light of the light emitting diode 120, hence the light source device 300 can provide uniform light.

As is understood by a person skilled in the art, the foregoing examples of the present disclosure are not a limitation. It is intended to cover various modifications and similar arrangements included within the spirit and scope of the appended claims, the scope of which should be accorded the broadest interpretation so as to encompass all such modifications and similar structures.

What is claimed is:

1. A light guide element, comprising:
a main body having a light-emitting surface, a bottom surface, and a side surface, wherein the side surface is located between the bottom surface and the light-emitting surface, and the bottom surface is opposite to the light-emitting surface, and the main body has a cone-shaped hollow portion used to receive exterior light, and the cone-shaped hollow portion comprises:
a bottom portion located at the bottom surface, and having a first hollow cross-sectional area; and
a top portion opposite to the bottom portion, and having a second hollow cross-sectional area, wherein the second hollow cross-sectional area is smaller than the first hollow cross-sectional area.

2. The light guide element of claim 1, wherein the cone-shaped hollow portion is in a shape of a polygon cone.

3. The light guide element of claim 1, wherein a contour of a cross section of a sidewall of the cone-shaped hollow portion is a curve, and the curve is formed from a plurality of straight lines.

4. The light guide element of claim 1, wherein the bottom portion of the cone has a center point, and a contour of a cross section of a sidewall of the cone-shaped hollow portion is a curve, and there is an angle included between the bottom portion and a line connected between the center point and a target point on the curve, and a slope of a tangent line corresponding to the target point is increased with the value of the angle.

5. The light guide element of claim 1, wherein the top portion of the cone-shaped hollow portion has an angle in a range from 20 degrees to 65 degrees.

6. A light source device, comprising:
a light guide element comprising a main body having a light-emitting surface, a bottom surface, and a side surface, wherein the side surface is located between the bottom surface and the light-emitting surface, and the bottom surface is opposite to the light-emitting surface, and the main body has a cone-shaped hollow portion used to receive exterior light, and the cone-shaped hollow portion comprises:
a bottom portion located at the bottom surface, and having a first hollow cross-sectional area; and
a top portion opposite to the bottom portion, and having a second hollow cross-sectional area, wherein the second hollow cross-sectional area is smaller than the first hollow cross-sectional area; and
a light source disposed adjacent to the bottom portion of the light guide element to emit light into the main body of the light guide element through the cone-shaped hollow portion.

7. The light source device of claim 6, wherein the cone-shaped hollow portion is in a shape of a polygon cone.

8. The light source device of claim 6, wherein a contour of a cross section of a sidewall of the cone-shaped hollow portion is a curve, and the curve is formed from a plurality of straight lines.

9. The light source device of claim 6, wherein the bottom portion of the cone has a center point, and a contour of a cross section of a sidewall of the cone-shaped hollow portion is a curve, and there is an angle between included the bottom portion and a line connected between the center point and a target point on the curve, and a slope of a tangent line corresponding to the target point is increased with the value of the angle.

10. The light source device of claim 6, wherein the top portion of the cone-shaped hollow portion has an angle from 20 degrees to 65 degrees.
